(19) United States
(12) Patent Application Publication
(10) Pub. No.: US 2006/0164201 A1
(43) Pub. Date: Jul. 27, 2006

(54) Method for adjusting the electrical resistance of a resistance path

(76) Inventors: Harald Guenschel, Gerach (DE); Roland Guenschel, Reutlingen (DE); Bernd Schumann, Rutesheim (DE); Lothar Diehl, Gerlingen (DE); Dirk Rady, Ditzingen (DE)

Correspondence Address: KENYON & KENYON LLP, ONE BROADWAY, NEW YORK, NY, 10004, US

(21) Appl. No.: 10/540,653

(22) PCT Filed: Nov. 17, 2003
(86) PCT No.: PCT/DE03/03800

§ 371 Date: Feb. 7, 2006

(30) Foreign Application Priority Data
Dec. 23, 2002 (DE) 102 60 852.0

(51) Int. Cl. H01C 7/13

(52) U.S. Cl. 338/22 R

(57) ABSTRACT

A method for adjusting the electrical resistance of an electrical resistor run running in meandering windings and situated between two layers, to a specified value at which the resistor run is produced having a lower resistance with reference to the specified value and having burn-up segments bridging meandering windings, and the adjustment is undertaken by cutting open selected burn-up segments. To achieve a simple adjusting method, constant current pulses having a controlled pulse duration are sent through the burn-up segments to cut open the burn-up segment.

### FIELD OF THE INVENTION

The present invention relates to a method for adjusting the electrical resistance of a resistor run, that runs in meandering windings between two layers, to a specified value.

### BACKGROUND INFORMATION

Layer composites having an embedded resistor run are used in various applications, such as in temperature sensors, for instance, for measuring the exhaust gas temperature in internal combustion engines, as referred to in German patent document no. 37 33 192 C1, or in heating devices for increasing the accuracy of measurement of lambda probes for the measurement of the oxygen concentration in the exhaust gas of an internal combustion engine, as are referred to in, for instance, German patent document no. 198 38 466 A1 or 199 41 051 A1. In such temperature sensors it is necessary that the highest resistance PTC resistor of the resistor run, which is embedded between ceramic foils made of aluminum oxide or a solid electrolyte such as zirconium oxide, should lie, conditioned by manufacturing, in an extremely small tolerance range, so as always to ensure, when it is in mass production, as accurate a temperature measurement as possible. In the case of heating devices for lambda probes, a sufficient measurement accuracy requires regulating the heating device so as to keep the operating temperature of the lambda probe constant. For this too, it is necessary that the lowest resistance resistor of the resistor run should move, conditioned by manufacturing, in a tight tolerance range, in order to avoid overcontrolling or undercontrolling the heating device.

Therefore, in both cases, a subsequent adjustment of the resistance value of the resistor run, that is, an adjustment, trimming or calibrating after the production of the layer composite, having an enclosed resistor run, is required, by suitable measures.

In one method for adjusting the resistance of a resistor run, embedded in a layer composite of a measuring sensor, to a specified value (German patent document no. 198 51 955 A1), in one of the layers coating the resistor run, a cutout is left free, through which the treatment of the resistor run for the adjustment of its internal resistance is undertaken. In the vicinity of the cutout, the resistor run has branchings and/or closed areas, so-called burn-up segments, and the adjustment is made by cutting open the branchings and/or closed areas, e.g. using a laser, whereby the resistance of the resistor run is increased. This is continued until the desired specified value is achieved. The resistance is continually measured using a circuit configuration connected to the resistor run. In heating devices in which the electrical resistor run is surrounded additionally by an insulation before it is covered by the layers of the layer composite, either the cutout is brought all the way through the insulation down to the plane of the resistor run, or the insulation is arranged in such a way that the laser is able to penetrate the insulation.

In both cases, after the laser adjustment, the cutout is closed by a filler substance, in order to protect the resistor run from mechanical ar chemical influences. A glass ceramic may be used as the filler substance, and after the filling, it is glazed by the thermal effect of the laser.

### SUMMARY OF THE INVENTION

The exemplary method according to the present invention may have the advantage that, for cutting open the burn-up segments for the purpose of adjusting or trimming the resistor run, no opening is necessary in one of the layers covering the resistor run. This enables one to do without the additional process step to close the opening, and avoids all the disadvantages in connection with the closing when the measuring sensor is installed in the exhaust gas of internal combustion engines, as a result of chemical or thermal degradation of the closing material; for, as a result of increasing electrical conductivity of the closing material, chemical degradation may lead to parasitic leakage currents, and thus to a flattening of the characteristics curve of the sensor element, and thermal degradation may lead to the failure of the sensor element by the breakup of the closing material. The cutting open of the burn-up segment takes place by energy-controlled current pulses, which have the effect of electrical vaporization of the burn-up segments made of the same material as the resistor run, so that for a suitable gradation of the resistances of the meandering windings or loops, e.g. a binary gradation, the resistance value of the resistor run may be increased at each occurrence of an additional burn-up segment.

In this context, because of the energy control, the burning up of the resistor run itself is reliably excluded.

According to another exemplary embodiment of the present invention, circuit traces are run directly to the connecting points of the burn-up segments to the meandering windings, and for the occurrence of a selected burn-up segment, the current pulse is injected into the two circuit traces leading to the selected burn-up segment. It is of advantage if the circuit traces are situated between the two connecting circuit traces leading to the resistor run and, same as the connecting circuit traces, are brought into the so-called cold region of the sensor element which is not exposed to the measured gas or exhaust gas. By contactings of the circuit traces in this area, the current pulses are able to be applied to the selected burn-up segments. Because of the high resistance insulation of the circuit traces for conducting the current pulses, the influencing of the low-resistance resistor run, that is to be adjusted, by parasitic leakage currents remains low even at high temperatures, so that the circuit traces have no effect that negatively influences the characteristics curve of the sensor element. For this reason, the selection of the material for the circuit traces may be optimized with regard to high specific conductivity, a low temperature coefficient and the high current loadability connected therewith, low costs and adaptation to the sintering temperature and the sintering atmosphere of the sensor element.

According to another exemplary embodiment of the present invention, constant current pulses are used as current pulses, whose pulse duration is controlled. Thereby one may set the energy required for cutting open a burn-up segment in an highly accurate manner, so that the meandering winding connected in parallel to the burn-up segment is not damaged, let alone burned open.

According to another exemplary embodiment of the present invention, the pulse duration is controlled in that the voltage falling off at the selected burn-up segment is monitored and, upon the detection of a more than proportional voltage increase, the pulse current is shut off.

According to another exemplary embodiment of the present invention, the burn-up segment is in the shape of a waist, whereby it is achieved that the greatest power transformation of the arc pulse takes place exactly at the thinnest location of the burn-up segment, and at that point it makes the material fuse. Since the meandering winding connected in parallel to the burn-up segment is more highly resistive, and, because of being embedded on both sides in an electrical insulation it has better heat coupling, the meandering resistor is not partially fused open by the energy-rich current pulse during the burning up of the burn-up segment.

According to another exemplary embodiment of the present invention, the molten open material of the burn-up segment is accommodated in a cavity formed in one of the two layers that cover the resistor runs. During the production of the sensor, the cavity is produced by printing over the burn-up segments using carbon-containing silk-screen printing paste, which completely oxidizes during sintering and goes over into the gas phase.

According to another exemplary embodiment of the present invention, one of the burn-up segments is connected to one of two connecting circuit traces that are brought to the end of the resistor run. To burn open a selected burn-up segment, the selected burn-up segment is heated and the current pulse is injected into the connecting circuit traces of the resistor run. Because of the local heating up of the selected burn-up segment from the outside, which may be done using a laser pulse at about 200° C., the specific resistance of the burn-up segment is increased, for instance, by a factor of two. At the heated point, at the narrowest place of the burn-up segment, additional energy is applied by the current pulse flowing in one part of the resistor run and in the burn-up segment, and this further increases the local heating, whereby additional heating is put in place that leads to the fusion of the selected burn-up segment. The fusing open of other burn-up segments by the current pulse is prevented by the absent local heating. This embodiment of the method has the advantage that one may do without applying additional circuit traces to the individual burn-up segments, which lowers manufacturing costs.

According to another exemplary embodiment of the present invention, at least one first burn-up segment is connected to one of two connecting circuit traces that are routed to the two ends of the resistor run, and at least one last burn-up segment is connected to an additional circuit trace that is routed out. To cut open a selected burn-up segment, it is heated and the current pulse is injected between the connecting circuit trace and the routed-out additional circuit trace. Providing an additional circuit trace to conduct the pulse from the burn-up segment to the outside has the advantage that the voltage required for keeping up the constant current pulse is clearly lower.

### BRIEF DESCRIPTION OF THE DRAWINGS

FIG. 1 shows a temperature sensor for measuring the exhaust gas temperature in an exploded illustration, in connection with a device for adjusting the measuring resistor.

FIG. 2 shows a top view of the measuring resistor in the temperature sensor according to FIG. 1, shown enlarged.

FIG. 3 shows an enlarged view of cutout III in FIG. 2.

FIG. 4 shows by way of cutout, a top view of the temperature sensor in FIG. 1 with the cover layer removed.

FIG. 5 shows the same representation as in FIG. 4 with a modification of the temperature sensor.

FIG. 6 shows an exploded illustration of a temperature sensor according to an additional exemplary embodiment, in connection with a device for adjusting the measuring resistance.

FIG. 7 shows a top view of the measuring resistor in the temperature sensor according to FIG. 6, shown enlarged.

FIG. 8 shows the curve plotted against time of current and voltage at a burn-up segment during adjustment of the measuring resistor in FIG. 1 or 6.

### DETAILED DESCRIPTION

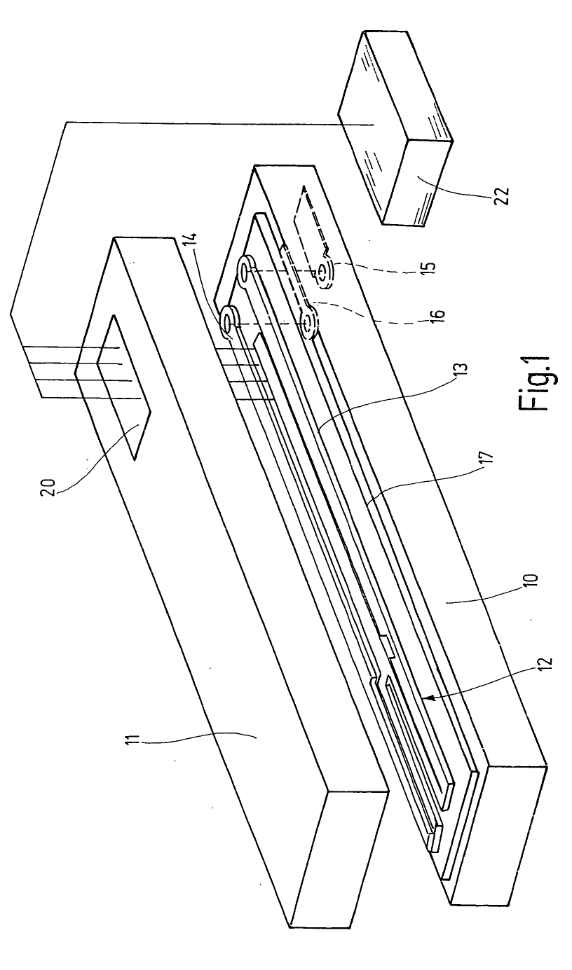

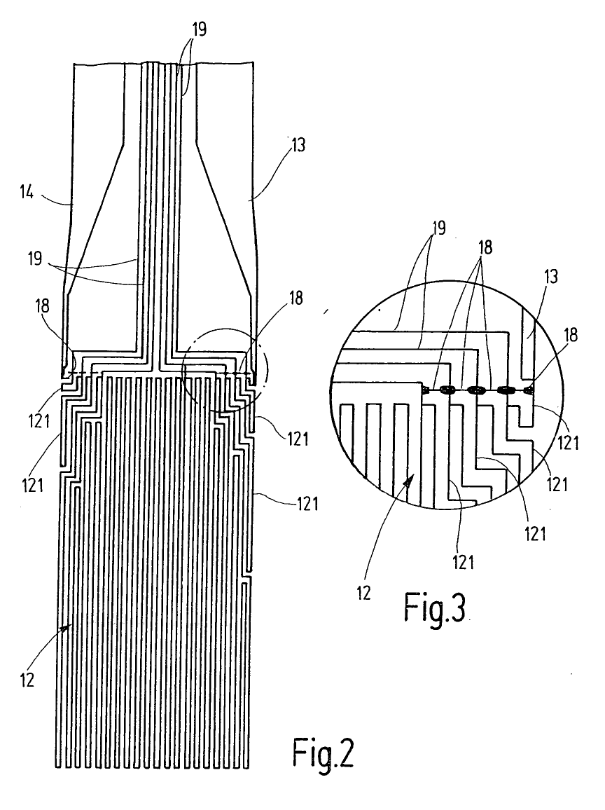

The temperature sensor or temperature measuring probe sketched in FIG. 1 in exploded illustration, for measuring the exhaust gas temperature of internal combustion engines, as exemplary embodiment for a general gas measuring probe, has a carrier 10, which may be made up, for example, of a ceramic foil based on solid electrolyte, for instance, of zirconium oxide (ZrO₂) and has a cover layer 11 which may also be a ceramic foil based on solid electrolyte. Between carrier 10 and cover layer 11 there is a measuring resistor in the form of a resistor run 12, made of PCT resistor material, which has a meandering structure having a plurality of meandering loops or meandering windings 121 (FIG. 2), and which lies in the so-called “hot” region of the sensor element that is exposed to the exhaust gas. From the two ends of resistor run 12 there extend two parallel connecting circuit traces 13, 14 into the “cold” region of the sensor element that is not exposed to the exhaust gas. At that location, two electrical contact surfaces 15, 16 are printed onto the underside of carrier 10, of which contact surface 15 is connected all the way through carrier 10 to connecting circuit trace 13, and contact surface [sic;16] is connected all the way through carrier 10 to connecting circuit trace 14. During the operation of the temperature sensor, contact surfaces 15, 16 are used for supplying measuring current. Resistor run 12, inclusive of the two connecting circuit traces 13, 14, is embedded in an electrical insulation, for instance, made of Al₂O₃, for which onto the upper side of carrier 10 a lower insulating layer 17 is printed, and onto the lower side of cover layer 11 an upper insulating layer is printed, which is not to be seen in FIG. 1. Resistor run 12 along with connecting circuit traces 13, 14 are printed onto lower insulating layer 17, for instance, by silk screen printing. Carrier 10 and cover layer 11 lie one on top of the other, and they are laminated together.

During the production of the sensor element, the geometry of resistor run 12 is developed in such a way that the measured cold resistance is less than a required specified value of the electrical resistance. At this point, in an adjustment process, the electrical resistance of resistor run 19 is increased in such a way that it is equivalent to the specified value within extremely tight tolerance boundaries.

Resistor run 19 is shown enlarged in FIG. 2 in a top view. It has a plurality of meandering windings 121 which are connected one after another between connecting circuit traces 13, 14. A part of meandering windings 121 on the left and the right sides of the layout, to be seen in FIG. 2, of resistor run 12, in the exemplary embodiment altogether eight meandering windings 121, are bridged in each case using a burn-up segment 18 in such a way that the entire meandering winding 121 is connected in parallel to burn-up segment 18. The adjacent meandering windings 121, in each case bridged by one burn-up segment 18, are gradated, for instance in binary fashion, in their resistance value, so that, upon burning up of a selected burn-up segment 18, the resistance of resistor run 12 is increased in a specified manner by a certain resistance value, namely that of meandering winding 121 that, at this point, is connected in series.

The burning up of burn-up segment 18 for the adjustment, trimming or calibration of resistor run 12 is performed by energy-controlled current pulses which are directed through selected burn-up segments 18. The current pulses are constant current pulses, whose pulse duration is controlled.

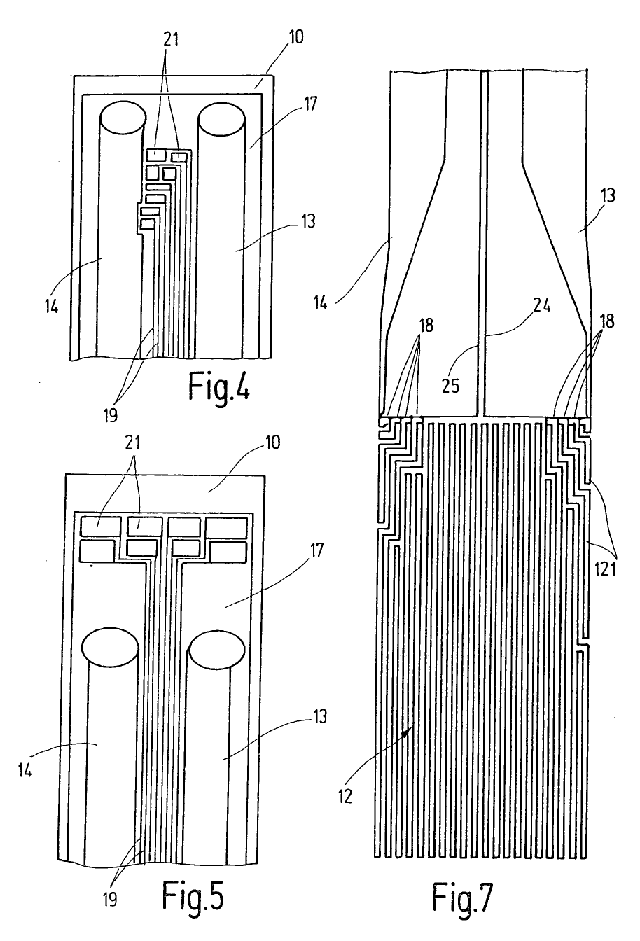

In order to be able to guide the current pulses to the burn-up segments, during production, circuit traces are put at the connecting points of meandering winding 121 and burn-up segments 18 that extend into the cold region of the sensor element and may be contacted there. In the exemplary embodiment of resistor run 12 shown enlarged in FIG. 2, having altogether eight burn-up segments 18, in total eight circuit traces 19 are required to run between the two connecting circuit traces 13, 14 for resistor run 12. To inject a current pulse into the two outermost burn-up segments 18, the two connecting circuit traces 13, 14 are also called upon. For contacting circuit traces 19, a cutout 20 is provided in the “cold” region of the sensor element in cover layer 11 and the upper insulating layer lying below it, which is closed if necessary after the end of the adjustment process. As shown in FIG. 4, in the region of circuit traces 19 opened up by cutout 20, contacting surfaces 21 are situated of which in each case one is connected to circuit traces 19. As may be seen most clearly in FIG. 3, burn-up segments 18, which are made of the same material as resistor run 12, for instance, of platinum, are arranged to have a much lesser width compared to resistor run 12. For example, the width of a meandering winding 121 amounts to 30-40 μm, and the width of a burn-up segment 18 amounts to 15-20 μm. Because of the substantially greater length of a meandering winding 121, the latter has a much higher resistance than burn-up segment 18. Besides that, burn-up segments 18 are waist-shaped, so that they are axially substantially thinner. Circuit traces 19 are arranged substantially wider than burn-up segments 18: in the exemplary embodiment, for example, the width being ca. 60 μm.

The electrical resistance of resistor run 12 of the sensor element thus prepared, finished and sintered, is adjusted to the higher specified value in an adjustment or trimming process, subsequent to the production process, as follows:

The resistance value of cold resistor run 12 is measured and, in the light of the resistance difference to the specified value, those burn-up segments 18 are established that should be disconnected in order to attain the required resistance value. Since the gradated resistance values of the meandering windings 121 in the layout of meander-shaped resistor run 12 are known, the required burn-up segments 18 may be determined without any trouble. Determined burn-up segments 18 are burned open one after another by applying a constant current pulse. To do this, an adjustment electronic system 22 is provided which, as is not shown any further here, has a constant current source, a switching thyristor and control electronics for switching the switching thyristor on and off. To generate the constant current pulse for burning open selected burn-up segment 18, the two circuit traces 19 leading to the selected burn-up segment 18 are contacted through cutout 20 and connected to adjusting electronics 22. When the switching thyristor is activated, the constant current source is connected to burn-up segment 18. As soon as burn-up segment 18 is fused open, the switching thyristor brings about an immediate separation of the constant current source from circuit traces 19. The current curve and the voltage curve at burn-up segment 18 during the closing of the switching thyristor and after the reopening of the switching thyristor is shown in FIG. 8, the solid line showing current curve I(t) and the broken line showing the voltage curve U(t) plotted against time t. The control of the pulse duration of the constant current pulse takes place in such a way that voltage U, that is dropping off at burn-up segment 18, is monitored from the beginning of turning on the switching thyristor. At burn-up segment 18, the voltage first rises in a linear manner, and then, when burn-up segment 18 is burned open, it rises exponentially as a result of the load change, which is utilized for blocking the switching thyristor. The switching thyristor, which has a very high cutoff sensitivity, such as 1.5V/100 nsec, cuts off the constant current source from circuit traces 19, so that the current pulse falls off to zero. Because of this control of the pulse duration, the current pulse has only the energy that suffices for the fusing of waist-shaped burn-up segment 18, but that does not damage meandering winding 121 that is connected in parallel, or change its resistance. The materially melted from burn-up segment 18 is accommodated in a cavity, not to be seen here, in cover layer 11, or rather, in the insulating layer printed onto it. During the production of the sensor, the cavity is produced by printing over burn-up segment 18 using carbon-containing silk-screen printing paste, which completely oxidizes during the sintering of the sensor element and goes over into the gas phase.

The adjusting procedure described may be carried out at a known room temperature and also at a known high temperature, or in a fluid medium, since the entire range of resistor run 12 is hermetically sealed. In order to achieve a higher thermal shock resistance as well as lower current densities, in the case of highly resistant burn-up segments 18, it is advantageous to perform the adjustment of resistor run 12 at higher temperatures, by self-heating or outside heating.

If one wishes to avoid using cutout 20 in cover layer 11, for the contacting of circuit traces 19, which is closed using insulating, gas-permeable material so as to prevent deposits on contacting surfaces 21 (e.g. electrically conductive soot) that influence the characteristics curve of the sensor element, then, as sketched in FIG. 5, during production of the sensor element, circuit traces 19 are routed to a region of carrier 10, lying behind the end of connecting circuit traces 13, 14, which is not covered by cover layer 11. In this region, in turn, each circuit trace 19 is connected to a contacting surface 21. After trimming of the sensor element, that is, after the adjustment of the electrical resistance of resistor run 12 to the required specified value, the region of carrier 10 not covered by cover layer 11 is cut off, including the circuit trace ends and contacting surfaces 21.

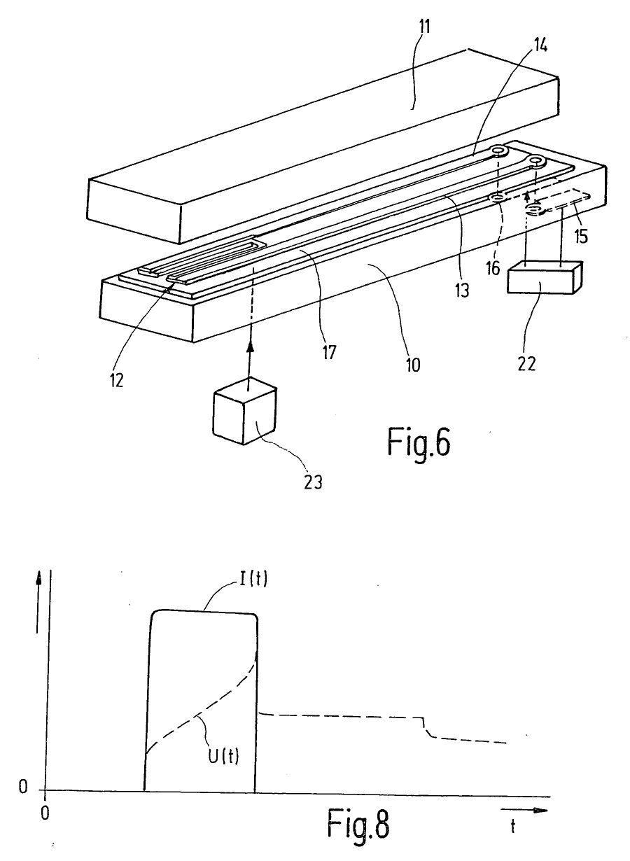

One modification of the adjusting method described allows for the necessity of bringing one circuit trace 19 to each burn-up segment 18 to be omitted. Of the burn-up segments 18 that are applied to resistor run 12 during the production of the sensor element and that bridge the corresponding meandering windings 121, the two first burn-up segments 18, which are connected in parallel to the left and the right of the meander of each meandering winding 121 (FIG. 7), are connected to respectively one of connecting circuit traces 13, 14 of resistor run 12. At this point in the adjusting process, adjusting electronics 22 are connected to the two contact surfaces 15, 16 of connecting circuit traces 13, 14, as shown in FIG. 6. If, after measuring the resistance values of resistor run 12 of the finished sensor element, the appropriate burn-up segments 18 have been established which are to be cut open in order to attain the specified value of resistor run 12, adjustment electronics 22, as described above, injects a constant current pulse into the two connecting circuit traces 13, 14. Before the injection of the current pulses, however, that particular burn-up segment 18, that is to be cut open, is locally heated using a laser pulse. The laser pulse is generated by a laser 23 in the infrared range, having a wavelength λ<2.5 μm. The laser pulse is directed all the way through carrier 10 and all the way through lower insulating layer 17 onto selected burn-up segment 18, so that there is good coupling to insulating layer 17. Applying the laser pulse all the way through cover layer 11 is disadvantageous, because at this location, there is present the cavity in cover layer 11 and the insulating layer lying below it, that was applied over burn-up segments 18. Based on the laser heating, the specific resistance of burn-up segment 18 increases compared to the other burn-up segments 18, for instance, by a factor of 2. The constant current pulse, sent at this point through resistor run 12, boosts the local heating using its energy, so that the power applied to the irradiated burn-up segment 18 by the current pulse is greater, for example, by a factor of two than for the remaining burn-up segments 18. This brings about a further heating that leads to the fusing of heated burn-up segment 18. Burn-up segments 18 are dimensioned in length, width and height in such a way that a transformation of energy takes place that is greater by 50% than in meandering windings 121 that are connected in series or in parallel to burn-up segment 18.

Since, in the case of a high resistance of resistor run 12, for maintaining the constant current pulses, a rather high adjusting voltage has to be raised by adjustment electronics 22, one or two additional circuit traces 24, 25 are routed to burn-up segments 18, as shown in FIG. 7. Of the altogether four meandering windings 121, which are bridged by a burn-up segment 18 in the outer region on the left and right sides of resistor run 12, first burn-up segment 18 is still connected to connecting circuit trace 13 or 14. The additional circuit trace 24 or 25 is routed to the last of burn-up segments 18 that lie one behind the other. At this point, adjustment electronics 22 is connected to connecting circuit trace 13 or 14 and to additional circuit trace 24 or 25. Additional circuit traces 24, 25 are contacted in the same manner as was described for circuit traces 19 with reference to FIGS. 4 and 5. After local heating of the selected burn-up segment 18, the current pulse is sent via connecting line 13 or 14, through a part of resistor run 12 and via additional circuit traces 24, 25, and heated burn-up segment 18 is cut open. Since the total resistance of the four meandering windings 121, that are connected in parallel or in series in the exemplary embodiment, is substantially less than the total resistance the resistor run 12, a clearly lower adjusting voltage is required for the application of the current pulses.

Basically, only one additional circuit trace 24 is sufficient if burn-up segments 18 are situated in such a way that the last of all burn-up segments 18 is connected to the only additional circuit trace 24. The two additional circuit traces 24, 25 are of advantage in the symmetrical layout of resistor run 12 shown in FIG. 7.

The adjustment methods described are not limited to the adjustment, described in exemplary fashion, of the measuring resistance of a temperature measurement sensor. It may just as well be drawn upon for the adjustment of the electrical resistance heater of a probe for determining the concentration of a gas component in a gas to be measured, e.g. the oxygen or nitrogen oxide concentration in the exhaust gas of internal combustion engines, in which a meander-shaped resistor run is arranged to have low resistance. In addition, the method may also be used in the case of multilayer hybrid circuits, since here, too, adjustment resistors are situated between the layers.

1-14. (canceled)

15. A method for adjusting an electrical resistance of a resistor run running in meandering windings and situated between two layers, the method comprising:
adjusting the electrical resistance to a specified value at which the resistor run is produced so as to have a lower resistance with reference to the specified value, wherein the resistor run includes burn-up segments and bridging meandering windings, wherein the adjusting is undertaken by cutting open selected ones of the burn-up segments; and
cutting open the burn-up segments by sending energy-controlled current pulses through the burn-up segments.

16. The method of claim 15, wherein the burn-up segments are situated so that at least for a part of the meandering windings, one of the burn-up segments is connected in parallel to each of the meandering windings.

17. The method of claim 16, wherein one of the burn-up segments is connected to one of two connecting circuit traces that are routed to two ends of the resistor run; and for cutting open a selected burn-up segment, the selected burn-up segment is heated and the current pulse is injected into the connecting circuit traces of the resistor run.

18. The method of claim 16, wherein at least one first burn-up segment is connected to one of two connecting circuit traces that are routed to two ends of the resistor run and at least one last burn-up segment is connected to an additional circuit trace, and wherein to cut open the selected burn-up segment by heating it and by injecting the current pulse between the connecting circuit trace and the additional circuit trace.

19. The method of claim 17, wherein the burn-up segment is heated, using a laser pulse, all the way through one of the two layers that covers the resistor run.

20. The method of claim 16, wherein circuit traces are routed to connecting locations of the burn-up segments and the meandering windings, and wherein for cutting open a burn-up segment, the current pulse is injected into the two circuit traces that are routed to a selected burn-up segment.

21. The method of claim 15, wherein constant current pulses are used as current pulses, and their pulse duration is controlled.

22. The method of claim 21, wherein a voltage falling off at a selected burn-up segment is monitored, and when a more than proportional voltage increase is detected, the current pulse is switched off.

23. The method of claim 17, wherein the injecting of a current pulse is performed using an electronic switch which connects a constant current source to the at lat least one of the circuit traces and the connecting circuit traces for a duration of the current pulse.

24. The method of claim 18, wherein the contacting of the circuit traces is undertaken all the way through a cutout that is worked into one of the layers that covers the resistor run.

25. The method of claim 18, wherein the circuit traces are routed by their trace ends into a region lying behind an end of the connecting circuit traces, in which they are covered only on one side by one of the layers, and this region is cut off after the adjustment of the resistor run.

26. The method of claim 15, wherein the burn-up segments are substantially more narrow than the meandering windings of the resistor run and than the circuit traces.

27. The method of claim 15, wherein the burn-up segments are waist-shaped.

28. The method of claim 15, wherein, in a region of the burn-up segments, a cavity is formed in one of the layers that covers the resistor run.
